(19) United States
(12) Patent Application Publication
(10) Pub. No.: US 2021/0182296 A1
(43) Pub. Date: Jun. 17, 2021

(54) ANOMALY LOCALIZATION DENOISING AUTOENCODER FOR MACHINE CONDITION MONITORING

(71) Applicant: Siemens Aktiengesellschaft, Munich (DE)

(72) Inventors: Chao Yuan, Plainsboro, NJ (US); Amit Chakraborty, East Windsor, NJ (US); Claus Neubauer, Marloffstein (DE)

(21) Appl. No.: 17/268,619

(22) PCT Filed: Aug. 24, 2018
(86) PCT No.: PCT/US2018/047839

§ 371 Date: Feb. 16, 2021

(51) Int. Cl. G06F 16/2455; G05B 23/02

(52) U.S. Cl. CPC G06F 16/24558; G06N 3/04; G05B 23/0256

(57) ABSTRACT

Systems, techniques, and computer-program products that, individually and in combination, permit machine condition monitoring are provided. In some aspects, state estimation and anomaly localization can be determined jointly. To that end, in some embodiments, systems can be configured using at least a synthetic training dataset. The synthetic training dataset includes sensor output data that incorporates synthetic a random amount of noise to each one of multiple sensor devices that probe an industrial machine. The training dataset also includes synthetic information indicative of location of anomalous sensor device(s) of the multiple sensor devices. Therefore, the systems can learn to determine state estimation and anomalous localization concurrently, in a single operation. Accordingly, the training of the systems is consistent with the operation of the systems during machine condition monitoring. Embodiments of the disclosure provide superior predictive performance over conventional machine condition monitoring approaches.

### BACKGROUND

An objective of machine condition monitoring is to detect machine failures at an early stage. Sensors that monitor a machine that operates normally can supply sensor output data distributed within a normal operating range. As such, sensor output data outside the normal operating range can reveal a potential or an actual failure.

A machine condition monitoring system typically provides operational condition information from two operations performed in tandem: A state estimation operation followed by an anomaly localization operation. Such a system determines anomaly localization information using, at least in part, information resulting from the state estimation operation.

Although such operations are clearly related, algorithms included in the state estimation operation are usually trained independently from other algorithms included in the anomaly localization operation. In addition, anomaly localization information is commonly generated based on manually or otherwise empirically defined rules that include defined thresholds for each sensor that monitors a machine. Therefore, much remains to be improved in condition monitoring of machines and other types of industrial equipment.

### BRIEF DESCRIPTION OF THE DRAWINGS

The accompanying drawings are an integral part of the disclosure and are incorporated into the present specification. The drawings, which are not drawn to scale, illustrate example embodiments of the disclosure and, in conjunction with the description and claims, serve to explain at least in part various principles, features, or aspects of the disclosure. Some embodiments of the disclosure are described more fully below with reference to the accompanying drawings. However, various aspects of the disclosure can be implemented in many different forms and should not be construed as being limited to the implementations set forth herein. Like numbers refer to like, but not necessarily the same or identical, elements throughout.

FIG. 1 presents an example of an operational environment for machine condition monitoring in accordance with one or more embodiments of the disclosure.

FIG. 2 presents an example of a system for machine condition monitoring in accordance with one or more embodiments of the disclosure.

FIG. 3 presents a diagram including training data for the configuration of an anomaly localization autoencoder in accordance with one or more embodiments of the disclosure.

FIG. 4 presents a graphical representation of relationships between input data and training data for the configuration of an anomaly localization denoising autoencoder in accordance with one or more embodiments of the disclosure.

FIG. 5 presents results of monitoring performance of several conventional techniques for equipment condition monitoring and the anomaly localization denoising autoencoder in accordance with one or more embodiments of this disclosure.

FIG. 6 presents an example of a method for machine condition monitoring in accordance with one or more embodiments of the disclosure.

FIG. 7 presents an example of a method for generating synthetic training data, in accordance with one or more embodiments of the disclosure.

FIG. 8 presents an example of an operational environment in which machine condition monitoring can be implemented in accordance with one or more embodiments of the disclosure.

### DETAILED DESCRIPTION

The disclosure recognizes and addresses, in at least some embodiments, the issue of machine condition monitoring. Embodiments of the disclosure include systems, techniques, and computer-program products that individually and/or in combination permit or otherwise facilitate, in a single operation, the estimation of an operational state of industrial equipment and the determination of anomaly localization corresponding to one or several sensors coupled to the industrial machine. In contrast to conventional systems and/or techniques for machine condition monitoring, embodiments of this disclosure provide a synthetic training dataset can permit or otherwise facilitate configuring a machine condition monitoring system to perform, jointly, state estimation and anomaly localization. The synthetic training dataset includes sensor output data that incorporates synthetic a random amount of noise to each one of a group of sensor devices that probe an industrial machine. The training dataset also includes synthetic information indicative of location of anomalous sensor(s). As such, rather than using normal sensor output data to learn a model for state estimation as it generally is the case in conventional technologies for machine condition monitoring machine condition monitoring systems of this disclosure can learn to determine state estimation and anomalous localization concurrently, in a single operation. Accordingly, the training of the systems of this disclosure is consistent with the operation of the systems during machine condition monitoring. Thus, embodiments of the disclosure can harmonize training objectives and testing objective, resulting in superior predictive performance over conventional approaches to machine condition monitoring.

Embodiments of this disclosure can provide numerous other technical improvements and benefits over conventional technologies for machine condition monitoring. For example, rather than relying on ad hoc expert rules to generate synthetic samples, some embodiments of this disclosure can generate synthetic samples by adding random deviations to respective training samples corresponding o normal output of sensors coupled to an industrial machine. The synthetic samples so generated can be utilized for sensor state estimation. As such, the disclosure relies on regression to solve an optimization problem with respect to a likelihood function that includes the synthetic samples. Therefore, this disclosure simplifies the solution of the optimization problem and, thus, permits identifying a solution faster than conventional technologies that rely on expert classification systems. In another example, conventional denoising autoencoders can map synthetic noisy samples to original noise-free samples, without reliance on noise location. In contrast, embodiments of the disclosure solve an optimization problem to map synthetically deviated samples to original normal output samples and to discover, concurrently, deviation location(s). As such, at least some embodiments of the disclosure can include and, thus, can be referred to as anomaly-localization denoising autoencoders. Thus, even if a conventional denoising autoencoder were applied to machine condition monitoring, the AL-DAEs disclosed herein still provide, at a minimum, concurrent determination of state estimate and anomaly localization. As such, in embodiments of the disclosure can permit or otherwise facilitate mitigating, or even avoiding entirely, the need to configure alarming thresholds for machine condition monitoring.

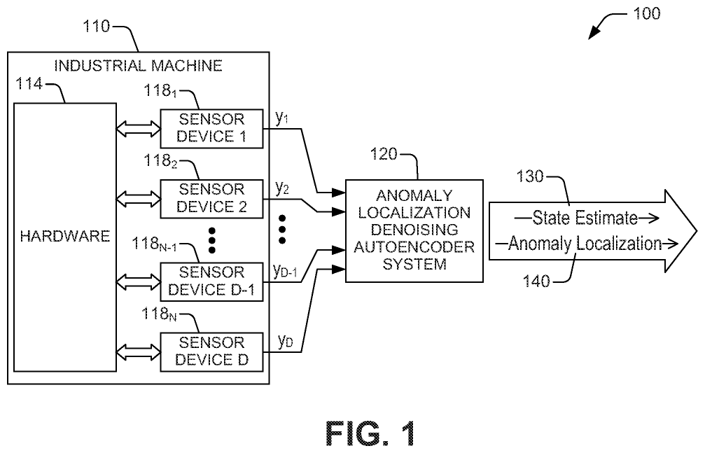

With reference to the drawings, FIG. 1 presents an example of an operational environment 100 for machine condition monitoring in accordance with one or more embodiments of the disclosure. The exemplified operational environment 100 includes an industrial machine 110 that has hardware 114 that permits of otherwise facilitates specific functionality of the machine. For example, the industrial machine 110 can be embodied in or can include an industrial boiler. Thus, the hardware 114 can include a hermetically sealable vat, tubing for ingress of fluid into the vat and other tubing for the egress of the fluid; valves for control of fluid injection into the vat; valves that control fluid (liquid and/or gas) egress from the vat; heater devices, one or more pumps to supply fluid to the vat; and the like. In another example, the industrial machine 110 can be embodied in or can include a gas turbine. Thus, the hardware 114 can include blades, a rotor, a compressor, a combustor, and the like.

A group of sensor devices can be integrated into or otherwise coupled to the hardware 114 to collect data indicative or otherwise representative of an operational state of the industrial machine 110. In some embodiments, the group of sensor devices can be homogeneous, including several sensor devices of a same type (e.g., pressure meters or temperature meters). In other embodiments, the group of sensor devices can be heterogeneous, where a first subset of the group of sensor devices corresponds to sensor devices of a first type and a second subset of the group of sensor devices corresponds to sensor devices of a second type. For instance, such a group of sensor devices can include pressure meter(s) and temperature meter(s). As is illustrated in FIG. 1, the group of sensor devices includes a sensor device 118₁, a second device 118₂, a sensor device D−1 118_{D-1}, and a sensor device D 118_{D}. Here D is a natural number greater than unity. Open, block arrows linking respective sensors and the hardware 114 depict integration of a sensor device into the hardware 114 or coupling of the sensor device to the hardware 114.

Each sensor device of the group of sensor devices can supply (e.g., generate and send) output data indicative or otherwise representative of magnitude of a physical property probed by the sensor device. The data can be supplied at defined times, e.g., in nearly real time, periodically, according to a schedule, or in response to polling by an external device. Data from the group of sensors at a defined time t can characterize or otherwise can be indicative of an observed operational state of the industrial machine 110 at the defined time t. Here, t is a real number in units of time).

As such, each one of the sensor devices k 118ₖ (k=1, 2 . . . D) can supply a datum (or record) yᵢ representative or a measurement of defined physical property at a defined time. A D-dimensional vector y=(y₁, y₂ . . . y_{D-1}, y_{D}) can represent an observed operational state at the defined time.

The exemplified operational environment 100 also can include an AL-DAE system 120 that can receive the D-dimensional vector y=(y₁, y₂ . . . y_{D-1}, y_{D}). Using at least y, the AL-DAE system 120 can jointly generate a state estimate 130 and anomaly localization 140. The state estimate 130 includes a D-dimensional vector x=(x₁, x₂ . . . x_{D-1}, x_{D}) that corresponds to the defined time associated with y. The D-dimensional vector x is indicative of an idealized fault-tree operational state corresponding to the observed operational state y. Plainly stated, without intending to be bound by theory and/or modeling, x conveys what the observed operational state of the industrial machine 110 would be under normal operational conditions.

The anomaly localization 140 includes a D-dimensional vector z=(z₁, z₂ . . . z_{D-1}, z_{D}) of binary values, each component zₖ (k=1, 2 . . . D) being indicative of an anomaly condition of the sensor device k 118ₖ. Each anomaly condition reveals absence of an anomaly (normal condition) or presence of an anomaly (fault condition). Each anomaly condition can have a first value (e.g., 1) corresponding to a fault condition or a second value (e.g., 0) corresponding to a normal condition.

Again, in sharp contrast to conventional machine condition monitoring system, the anomaly localization 140 is determined jointly with the state estimate 130, in a single operation performed by the AL-DAE 120. As such, AL-DAE system 120 determines the anomaly localization without reliance on a first operation to determine a residual vector r=y−x=(r₁, r₂ . . . r_{D-1}, r_{D}) and a subsequent, distinct operation to compare each component of rₖ (k=1, 2 . . . D) to a first alarming threshold Tₖ^{(low)} and a second alarming threshold Tₖ^{(high)}>Tₖ^{(low)}. If a conventional system were applied to the industrial machine 110, the difference Tₖ^{(high)}−Tₖ^{(low)} would convey a normal output range for sensor device k 118ₖ. Thus, if a conventional system were applied to condition monitoring of the industrial machine 110, a value rₖ within range (e.g., Tₖ^{(low)}<rₖ<Tₖ^{(high)} would convey normal operation of the sensor k 118ₖ, resulting in zₖ=0, for example. Otherwise, still considering a conventional system, a value rₖ outside range would result in zₖ=1, for example. Yet, the AL-DAE system 120 avoids the configuration and use of such alarming thresholds to determine the anomaly localization 140.

In order to jointly generate a state estimate 130 and anomaly localization 140 using a sensor observation y=(y₁, y₂ . . . y_{D-1}, y_{D}), synthetic sensor output samples and synthetic anomaly localization samples are generated. Such samples are utilized to solve an optimization problem to obtain a model that can map synthetic anomalous samples to normal sensor output samples and can determine, concurrently, anomalous location(s). In some embodiments, synthetic sensor output samples can be generated by adding synthetic noise to defined sensor devices of the group of sensor devices 118₁-118_{D}. The synthetic noise can be embodied in or can include random noise based at least on a defined probability distribution that depends on information of corrupted sensor location. Such a defined probability distribution provides anomaly location.

Although conventional techniques for DAEs may include synthetic samples, conventional DAEs fail to incorporate information of corrupted or otherwise anomalous sensor device location. In sharp contrast, the AL-DAE system 120 can utilize an AL-DAE that incorporates both synthetic sensor output sample and such information. It is noted that information of corrupted or otherwise anomalous sensor device location can provide anomaly location information. Therefore, the AL-DAE system 120 can provide an improvement over conventional approaches for DAEs by generating state estimation and anomaly localization concurrently, in a single operation rather than in tandem operations as is the case in conventional technologies. Accordingly, in sharp contrast to the AL-DAEs disclosed herein, even if a conventional DAE is applied to machine condition monitoring, the conventional DAE would fail to provide any type of anomaly location.

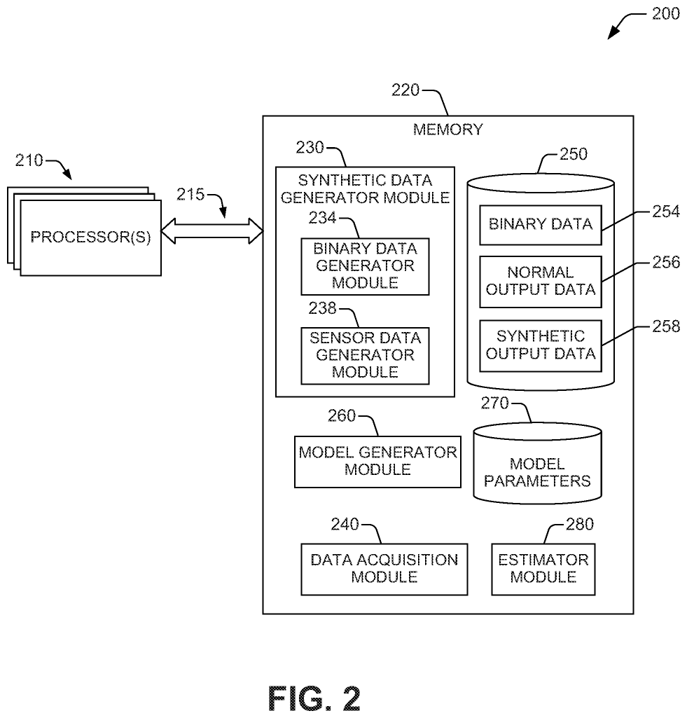

FIG. 2 presents an example of a machine condition monitoring system 200 for generating an AL-DAE for machine condition monitoring in accordance with one or more embodiments of the disclosure. In some embodiments, the machine condition monitoring system 200 can embody or can include the AL-DAE 120 shown in FIG. 1 and described in connection therewith. As is illustrated, the exemplified system 200 includes one or more processors 210 that, individually or in combination, can execute modules retained (e.g., stored, made available, or stored and made available) in one or more memory devices 220 (generically referred to as memory 220) to provide various training functionalities of this disclosure.

The machine condition monitoring system 200 can generate training datasets that include synthetic anomaly localization datasets and synthetic sensor output datasets for the group of sensor devices 118ₐ-118_{D}. Such datasets are synthetic because the machine condition monitoring system 200 relies on a group of parameters to generate data records (or samples) randomly. The group of parameters characterize, at least in part, a model for such training datasets. Within such a model, a synthetic anomaly localization dataset includes a set {Z} of N samples of D-dimensional vectors, each having binary values. Namely, {Z}={z⁽¹⁾, z⁽²⁾, . . . z^{(N)}}, where N is a natural number greater than unity. In addition, a synthetic sensor output dataset includes a set {Y} of N samples of D-dimensional vectors: {Y}={y⁽¹⁾, y⁽²⁾, . . . y ^{(N)}}.

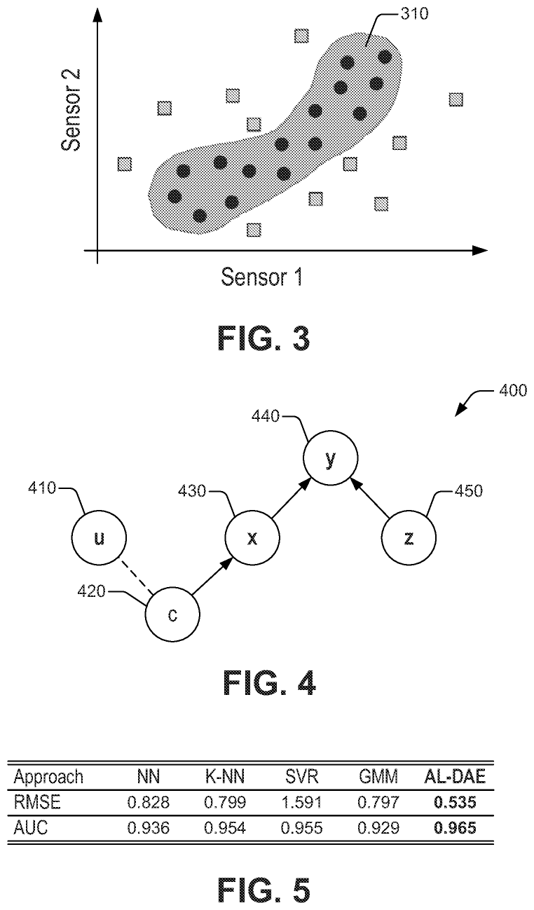

As an illustration, in a scenario in which D=2. FIG. 3 depicts schematically an example of N=26 synthetic sensor output samples relative to a normal operating range 310. Solid squares represent abnormal synthetic samples and solid circles represent normal synthetic samples. As mentioned, some conventional approaches for machine condition monitoring can exclusively utilize synthetic samples within the normal operating range 310. In sharp contrast, the machine condition monitoring system 200 utilizes both normal sample and abnormal samples to train an AL-DAE in accordance with this disclosure.

The machine condition monitoring system 200 can generate a synthetic sensor output dataset using at least a synthetic anomaly localization dataset the set {Z} and a normal sensor output dataset for the industrial machine 114 or another industrial equipment being monitored. The normal sensor output dataset includes a set {X} of N samples of D-dimensional vectors {x⁽¹⁾, x⁽²⁾, . . . x^{(N)}} that correspond to normal operation of the industrial machine 114 or other industrial equipment. The relationship amongst such datasets is illustrated in a graph 400 in FIG. 4. The graph 400 includes nodes that represent variables and edges represent dependencies. A node 430 represents a sample of the set {X} and a node 450 represents a sample of the set {Z}. A first directed edge connects the node 430 to a node 440 that represents a synthetic sensor output sample y of the set {Y}. A second directed edge connects the node 450 to the node 440.

The graph 400 also includes a node 420 labeled as “c.” The parameter c is a cluster indicator and conveys an operating mode of the industrial machine 110 or other industrial equipment being monitored. As such, a normal sensor output sample x can be determined, at least in part, by c. Thus, a directed edge connects the node 420 to the node 430. The parameter c can range from 1 to K (a natural number that represents a total number of operating modes (or clusters)). While in some embodiments K=100 in considered for the generation of a AL-DAE of this disclosure, other values can be implemented.

In some embodiments, c can be determined based at least on output from one or more of the sensors devices 118₁-118_{N}. In the graph 400, such an output is represented with a node 410 labeled “u.” In some embodiments, a embody or otherwise include system inputs of the industrial machine 110 (or other industrial equipment) that are not subject to abnormal behavior. A dashed edge connects node 410 and node 430 to represent that c can depend at least on u or vice versa.

More concretely, to generate a training sample in accordance with this disclosure, the machine condition monitoring system 200 can randomly select the cluster indicator c. As mentioned, c indicates a mode of operation of the industrial machine 110 or other industrial equipment being monitored. In some embodiments, the cluster indicator can be randomly selected according to a uniform distribution probability P(c)=1/K. To such an end, in some embodiments, the memory 220 can retain or otherwise store a synthetic data generator module 230. In addition, the at least one of the processor(s) 210 can execute the synthetic data generator module 230 to cause the at least one processor to generate c.

In other embodiments, c can be determined by sensor signals (see, e.g., node 410 in FIG. 4). Signals u embody or otherwise include, for example, system inputs that are not subject to abnormal behavior. In a scenario in which u depends on c (e.g., a mode of operation determines a magnitude of u), the machine condition monitoring system 200 can sample c as a multivariate Gaussian distribution N(·) having mean and standard deviation θ:

P(u|c)=N(u|μ_{c}, θ² [symbol] ), (1)

where [symbol] is an identity matrix having defined dimensions. In another scenario in which c depends on u, the machine condition monitoring system 200 can sample c as a multinomial distribution:

P(c|u)=f(u, c, θ), (2)

where f(u, c, θ) is a softmax function that can be defined, for example, by a feedforward neural network.

For a defined cluster indicator c (or mode of operation), the machine condition monitoring system 200 can randomly select a sample x from a normal sensor output dataset that corresponds to normal operation of the industrial machine 114 or other industrial equipment to be monitored. The sample x can be embodied in a D-dimensional vector having D components, each corresponding to normal sensor output data from one of the sensor devices 118₁-118_{D}. To select the sample x, at least one of the processor(s) 210 can execute the synthetic data generator module 230 to cause the at least one processor to determine or otherwise identify the sample x according to, for example, a probability distribution

P(x|c)=N(m_{c}, σ² [symbol] ). (3)

In Eq. (3) above, [symbol] is an identity matrix having defined dimensions, and N(·) is a Gaussian distribution having a mean m_{c} and standard deviation σ.

As is disclosed herein, for the group of sensor devices that includes sensor device 118₁ to sensor device 118_{D}, an anomaly localization sample z can be embodied in a D-dimensional vector having binary values. More formally, z=(z₁, z₂ . . . z_{D-1}, z_{D}), where zₖ (k=1, 2 . . . D) is a binary value. To generate the synthetic anomaly location sample z, the machine condition monitoring system 200 can assign randomly one of a first value or a second value to each component zₖ. corresponding to sensor device 118ₖ. As is disclosed herein, each of the first value and the second value indicate a defined anomaly condition. Thus, in some embodiments, the first value can be equal to unity and can indicate presence of an anomalous condition for the sensor device 118ₖ. In addition, the second value can be equal to zero and can indicate the absence of an anomalous condition for the sensor device 118ₖ.

Accordingly, in some embodiments, the synthetic data generator module 230 can include a binary data generator module 234 that can be executed to perform a random assignment of one of the first value or the second value for each one of the D components of the synthetic anomaly localization sample z. In one aspect, at least one of the processor(s) 210 can execute the binary data generator 234 and, in response, the at least one of the processor(s) 210 can perform such random assignment. Anomaly localization samples generated in such a fashion can be retained in a data structure 254 (referred to as binary data 254).

Specifically, each component zₖ of the anomaly localization sample z can be generated according to a uniform probability distribution p(zₖ) where

$$p ( {z}_{i} ) = \{ \begin{matrix}{p}_{a} , & for {z}_{i} = 1 \\ 1 - {p}_{a} , & for {z}_{i} = 0\end{matrix} , \qquad ( 4 )$$

where pₐ is indicative of an anomaly probability and has a defined value (e.g., 0.1, 0.2, or the like). It is noted that, without intending to be bound by theory and/or modeling, the anomaly probability controls the sensitivity of anomaly detection. A smaller pa yields less sensitivity in anomaly detection. Thus, a synthetic anomaly localization sample z can be sampled according to the following probability distribution:

$$P ( z ) = {\prod }_{k = 1}^{d} p ( {z}_{k} ) \qquad ( 5 )$$

As mentioned, synthetic sensor output datasets {Y} of this disclosure incorporate anomaly condition information for each (or, in some embodiments, at least one) sensor device of a group of sensor devices (e.g., sensor devices 118ₐ-118_{D}) that can probe an operational state of industrial equipment (e.g., industrial machine 110). Therefore, anomaly is introduced to each sensor that as a corresponding anomaly indicator that conveys a fault condition (e.g., zₖ=1). To that end, the machine condition monitoring system 200 can generate a synthetic output sensor component yₖ by incorporating a random deviation into a corresponding normal sensor output component xₖ. Such a deviation can be determined according to a Gaussian distribution N(·) having mean xᵢ and a standard deviation σₐ (here, subscript a stands for “anomaly”). Specifically,

Pₐ(yₖ|xₖ, zₖ=1)=N(yᵢ|xₖ, σₐ²). (6)

Similarly, in instances in which an anomaly indicator conveys a normal condition (e.g., zₖ=0), the machine condition monitoring system 200 can generate a synthetic output sensor component yₖ according to another Gaussian distribution N(·) having mean xᵢ and a standard deviation σₙ (here, subscript n stands for “normal”):

Pₙ(yₖ|xₖ, zₖ=0)=N(yᵢ|xₖ, σₙ²). (7)

Without intending to be bound by theory and/or simulation, σₐ can be large to allow large abnormal deviation and σₙ can be small to constrain deviation under normal conditions.

As such, the synthetic data generator module 230 also can include a sensor data generator module 238 that can be executed to generate a sample of component yₖ according to Pₐ(yₖ|xₖ, zₖ=1) and Pₙ(yₖ|x ₖ, zₖ=0) for for zₖ=1 and for zₖ=0, respectively. At least one of the processor(s) 210 can execute the sensor data generator module 238 and, in response, the at least one of the processor(s) 210 can generate the sample of component yₖ. Samples generated in such a fashion can be retained in a data structure 258 (referred to as synthetic output data 258).

The machine condition monitoring system 200 can generate a synthetic training dataset by generating multiple training samples. As mentioned, the training dataset is based at least on synthetic anomaly localization information, as is disclosed herein. The synthetic training dataset can be expanded or otherwise updated by generated additional training samples. In some aspects, the synthetic training dataset is be utilized to train a model represented, for example, by the set of parameters {Ω}={θ, σ, m₁, m₂, . . . m_{K}, σₙ, σₐ}, where K modes of operation are contemplated. The set of parameters {Ω} can be retained or otherwise stored in a data structure 270 (referred to as model parameters 270).

Training the model refers to determining (or, in artificial intelligence (Al) parlance, learning) the set of parameters {Ω} that solve an optimization problem with respect to a defined objective function. The objective function can be embodied in a sum of the log-likelihood of a set of M samples for each one of a normal sensor output set {X}={x⁽¹⁾, x⁽²⁾, . . . x^{(M)}}, a synthetic anomaly localization set {Z}={z⁽¹⁾, z⁽²⁾, . . . z^{(M)}}, and a synthetic sensor output set {Y}={y⁽¹⁾, y⁽²⁾, . . . y^{(N)}}. Each one of the sample in {Z} and {Y} is generated in accordance with aspects described herein. Here, M can be referred to as batch size and is a natural number greater than unity.

Specifically, the optimization problem includes the maximization of the following objective function:

$${max}_{Ω} {\sum }_{n = 1}^{M} log P ( {x}^{( n )} , {z}^{( n )} \vert {y}^{( n )} , {u}^{( n )} , Ω ) \qquad ( 8 )$$

Note that Eq. (8) includes probability of both x and z, conditioned on observation y and system inputs u. Therefore, by solving the optimization problem posed by Eq. (8), the machine condition monitoring system 200 can learn state estimation and anomaly localization jointly. Accordingly, in a clear improvement over conventional approaches to machine condition monitoring, the machine condition monitoring system 200 can be configured as an AL-DAE system that is consistent with the objective of testing during active monitoring of the industry machine 110 or other industrial equipment being monitored. To that point, as is illustrated in FIG. 5 and discussed below, the AL-DAE system 120 provides superior results for both state estimation and anomaly localization than conventional approaches for machine condition monitoring.

In some embodiments, solving the optimization problem posed by Eq. (8) can include iteratively updating the set of parameters {Ω} to determine a maximum of the sum of log-likelihoods log P(x⁽ⁿ⁾, z⁽ⁿ⁾|y⁽ⁿ⁾, u⁽ⁿ⁾, Ω) over a batch of M samples. To such an end, the machine condition monitoring system 200 can include a model generator module 260 that can be executed to solve the foregoing optimization problem. One or more processor includes in the processor(s) 210 can execute the model generator module 260 and, in response, the one or more processors can solve the optimization problem in such a fashion.

More concretely, at a current iteration q (a natural number), the model generator module 260 can be executed to configure a current set of parameters {Ω^{(q)}}. In addition, the synthetic data generator module 230 can be executed (or can continue to be executed) to select a batch of M samples of a normal sensor output dataset {X}_{q}. In one aspect, the M samples of the normal sensor output dataset can be selected randomly as is disclosed herein. Further, based at least on {Ω^{(q)}} and {X}_{q}, the synthetic data generator module 230 can be executed (or can continue to be executed) to generate respective batches of M samples for each one of a synthetic anomaly localization dataset {Z}_{q} and a synthetic sensor output dataset {Y}_{q+1}. As is disclosed herein, the batch of M samples can be randomly generated according to defined probability density functions characterized by the current set of parameters {Ω^{(q)}} and using the M samples in {X}_{q}, as is disclosed herein. The normal sensor output dataset {X}_{q} can be retained in a data structure 256 (referred to as normal output data 256). Datasets {Y}_{q} and {Z}_{q} can be retained in binary data 254 and synthetic output data 258, respectively.

Therefore, at the current iteration q, a maximum of the log-likelihood function for the current set {Ω^{(q)}} can be determined by performing an expectation-maximization (EM) process. As mentioned, an analytic closed form of the log-likelihood function may not be available and, thus, a Monte Carlo technique can be utilized to implement the EM process. To that point, the model generator module 260 can be executed (or can continue to be executed) to perform the EM process and obtain an updated set of parameters {Ω^{(q+1)}} that are utilized in a next iteration q+1.

At the next iteration q+1, the synthetic data generator module 230 can be executed (or can continue to be executed) to select another batch of M samples of a normal sensor output dataset {X}_{q+1}. The M samples of {X}_{q+1} also can be selected randomly as is disclosed herein. Further, execution of the binary data generator module 234 can produce a synthetic anomaly localization dataset {Z}_{q+1}, and execution of the sensor data generator module 238 can produce a synthetic sensor output dataset {Y}_{q+1}. The model generator module 260 can be executed (or can continue to be executed) to determine a maximum of the log-likelihood function for the current set {Ω^{(q+1)}} can be determined by performing the EM process. Therefore, another updated set of parameters {Ω^{(q+2)}} is generated.

At each next iteration q+1, q+2, and so forth, the model generator module 260 can be executed (or can continue to be executed) to assess if a convergence criterion is satisfied and, therefore, a solution of the optimization problem has been determined. The convergence criterion can correspond to a threshold amount for an improvement in the increment of the log-likelihood function after the next iteration is completed. Such an improvement that is less than the threshold amount can represent the convergence of the iterative updates to the set of model parameters {Ω}. Thus, the optimization problem can be considered solved.

Upon or after model parameters model parameters have converged—e.g., an AL-DEA DEA of the disclosure has been trained or otherwise the machine condition monitoring system 200 can receive an actual observation y^{(obs)} from the industrial machine 110 and can determine state estimation and anomaly localization concurrently, in a single operation. To that end, one or more of the processor(s) 210 can execute the data acquisition module 240 to receive and retain y^{(obs)} in the repository 250 (e.g., a database). In addition, the one or more of the processor(s) 210 can execute the estimator module 280 to cause such processor(s) to generate, jointly, an estimate of a normal state vector x and an estimate of anomaly localization z using at least y^{(obs)}.

More specifically, the estimator module 280 can be executed to cause generate a state estimation by determining by the following conditional probability:

$$P ( x \vert {y}^{( obs )} ) = {\sum }_{c} P ( x \vert {y}^{( obs )} , c ) P ( c \vert {y}^{( obs )} ) \qquad ( 9 )$$

Here c is a cluster indicator that ranges from 1 to K, as described above. In addition, execution of the estimator module 280 cause the one or more of the processor(s) to generate an estimate of anomaly localization by determining the following conditional probability:

$$P ( z \vert {y}^{( obs )} ) = {\sum }_{c} P ( z \vert {y}^{( obs )} , c ) P ( c \vert {y}^{( obs )} ) \qquad ( 10 )$$

One or more of the processor(s) 210, the bus 215, and the estimator module 280 and converged model parameters retained in the memory 220 can embody or otherwise constitute the AL-DAE system 120. Using the actual observation y^{(obs)}, the AL-DAE system 120 can generate, jointly, the estimate of the normal state vector x (e.g., state estimate 130) and the estimate of anomaly localization z (e.g., anomaly localization 140) as is described herein.

As an illustration, embodiments of the disclosure can be applied to gas turbine operation data. Specifically, the industrial machine 110 can be embodied in gas turbine and the AL-DAE system 120 can be applied to operation data of the gas turbine. The group of sensor devices 118₁-118_{D} can include, for example, D=14 assembled in the compressor and combustor of the gas turbine. The group of sensors can probe fuel level, air flow, humidity, various temperatures, and pressures.

In this illustration, a total of 1000 operation data records obtained from the gas turbine can be split into two groups: A first group consists of 300 data records used for training (or configuration) of the AL-DAE system 120, and a second group consists of 700 data records used for testing.

Applying a trained AL-DAE system 120 to the group of 700 operation data records yield results that are compared with several conventional approaches, including a nearest neighbor (NN) approach; a k-NN approach; a support vector regression (SVR) approach; and a Gaussian mixture model (GMM) approach. For the k-NN approach, k=5 is considered. It is noted that in the NN approach, a 14-dimensional vector x corresponding a state estimate 130 is predicted by determining the nearest neighbor in the training group of 300 data records. In the k-NN, such an x is predicted by averaging k (five, for example) nearest neighbors in the training group. In the embodiment utilized for the generation of the results summarized in FIG. 5, the training of the AL-DAE system 120 does not include inputs u (see node 410 in FIG. 4 and associated description).

The performance of the AL-DAE system 120 of this disclosure and the performance of the conventional approaches are determined by generating two types of test scores: (1) Root mean squared error (RISE) to evaluate state estimation accuracy. Smaller RASE values indicate better performance. (2) Area under curve (AUC) to evaluate anomaly localization accuracy. Larger AUC values represent better performance. As is illustrated in FIG. 5, the AL-DAE system 120 in accordance with aspects of this disclosure outperforms the tested conventional approaches in both accuracy of state estimation and accuracy of anomaly localization.

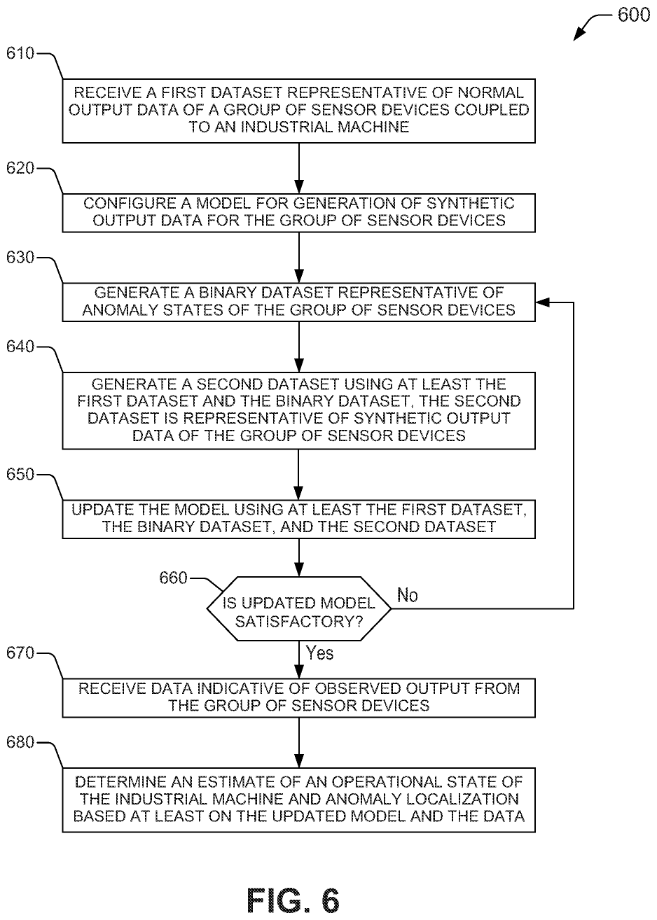

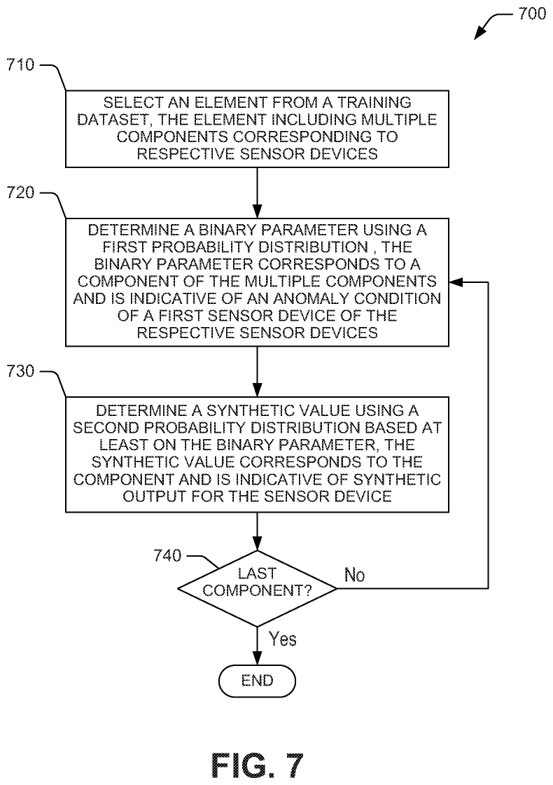

In view of various aspects described herein, examples of methods that can be implemented in accordance with this disclosure can be better appreciated with reference to FIGS. 6-7. For purposes of simplicity of explanation, the exemplified methods (and other techniques disclosed herein) are presented and described as a series of operations. It is noted, however, that the exemplified methods and any other techniques of this disclosure are not limited by the order of operations. Some operations may occur in different order than that which is illustrated and described herein. In addition, or in the alternative, some operations can be performed essentially concurrently with other operations (illustrated or otherwise). Further, not all illustrated operations may be required to implement an exemplified method or technique in accordance with this disclosure. Furthermore, in some embodiments, two or more of the exemplified methods and/or other techniques disclosed herein can be implemented in combination with one another to accomplish one or more elements and/or technical improvements disclosed herein.

In some embodiments, one or several of the exemplified methods and/or other techniques disclosed herein can be represented as a series of interrelated states or events, such as in a state-machine diagram. Other representations also are possible. For example, interaction diagram(s) can represent an exemplified method and/or a technique in accordance with this disclosure in scenarios in which different entities perform different portions of the disclosed methodologies.

It is noted that the techniques disclosed herein, such as the example methods in FIGS. 6-7, can be retained or otherwise stored on an article of manufacture (such as a computer-program product) in order to permit or otherwise facilitate transporting and transferring such example methods to computers for execution, and thus implementation, by processor(s) or for storage in a memory.

Methods disclosed throughout the subject specification and annexed drawings are capable of being stored on an article of manufacture to facilitate transporting and transferring such methodologies to computers or other types of information processing machines or processing circuitry for execution, and thus implementation by a processor or for storage in a memory device or another type of computer-readable storage device. In one example, one or more processors that perform a method or combination of methods disclosed herein can be utilized to execute programming code instructions retained in a memory device or any computer-readable or machine-readable storage device or non-transitory storage media, to implement one or several of the exemplified methods and/or other techniques disclosed herein. The programming code instructions, when executed by the one or more processors can implement or carry out the various operations in the exemplified methods and/or other technique disclosed herein.

The programming code instructions, therefore, provide a computer-executable or machine-executable framework to implement the exemplified methods and/or other techniques disclosed herein. More specifically, yet not exclusively, each block of the flowchart illustrations and/or combinations of blocks in the flowchart illustrations can be implemented by the programming code instructions.

FIG. 6 presents a flowchart of an example method 600 for machine condition monitoring in accordance with one or more embodiments of the disclosure. The example method 600 can be implemented, entirely or in part, by a computing system having one or more processors, one or more memory devices, and/or other types of computing resources. In some embodiments, the computing system can be embodied in or can include the machine condition monitoring system 200 or the AL-DAE system 120.

At block 610 the computing system can receive a first dataset representative of normal output data of a group of sensor devices coupled to an industrial machine (e.g., a gas turbine). In some embodiments, the group of sensor devices includes a combination of two or more of sensor device 1 118₁ to sensor device D 118_{D}, and the industrial machine is embodied in or includes industrial machine 110. As mentioned, the first dataset can include multiples vectors, each having a number of components corresponding to the number of sensors in the group of sensor devices.

At block 620 the computing system can configure a model for generation of synthetic output data for the group of sensor devices. As mentioned, the model can be characterized by a set of parameters {Ω} that define, at least in part, several probability distributions.

At block 630, the computing system can generate a binary dataset representative of anomaly states (or anomaly conditions) of the group of sensor devices. As described herein, an anomaly state can be defined by a specific combination of anomaly conditions of respective sensors in the group sensor devices. Each anomaly condition reveals absence of an anomaly (normal condition) or presence of an anomaly (fault condition). Each anomaly condition can have a first value (e.g., 1) corresponding to a fault condition or a second value (e.g., 0) corresponding to a normal condition. As such, an anomaly state can be represented by a vector of z of binary values, the vector z having a number of components that is equal to the number of sensors in the group of sensor devices. The binary dataset can be represented as {Z} and can have a defined number N of vectors z. Here, N is a natural number greater than unity.

At block 640, the computing device can generate a second dataset using at least the first dataset and the binary dataset. The second dataset is representative of synthetic output data of the group of sensor devices, and includes several vectors y, each having components corresponding to synthetic output from respective sensors of the group of sensor devices. The second dataset can be represented as {Y} and can have N vectors y.

At block 650, the computing device can update the model using at least the first dataset, the second dataset, and the binary dataset. Updating the model can include determining a new set of parameters {Ω′} that replaces a current set of parameters (such as {Q} configured at block 620) and characterizes an updated model. As mentioned, updating the model can include solving an optimization problem with respect to a log-likelihood function based at least on the first dataset, the second dataset, and the binary dataset. In some embodiments, as disclosed herein, solving the optimization problem can include maximizing such a log-likelihood function. The optimization problem can be solved using numerous approaches. For example, a maximum of the log-likelihood function can be determined performing an EM process. As mentioned, an analytic closed form of the log-likelihood function may not be available and, thus, a Monte Carlo technique can be utilized to implement the EM process.

At block 660, the computing device can determine if the updated model from block 550 is a satisfactory model—e.g., difference between the new set of parameters {Ω′} and the current set of parameters satisfies a convergence criterion. In response to a negative determination, the flow of the example method 600 is directed to block 630, for further sampling and another model update. In the alternative, an affirmative determination causes the flow to proceed to block 670, at which the computing system can receive data indicative of observed output from the group of sensors. At block 680, at which an estimate of the state of the industrial machine and anomaly localization can be determined jointly based at least on the updated model and observed output data from the group of sensor devices coupled to the industrial machine. While not depicted, the computing system that performs the example method 600 can send the estimate of the operational state of the industrial machine and the anomaly localization to a computing device for presentation or further analysis, such as root cause analysis.

Collectively, blocks 610 to 660 can embody or can constitute a training stage of a machine condition monitoring system. Blocks 670 and 680 can embody or can constitute a training stage of the machine condition monitoring system.

FIG. 7 presents a flowchart of an example method 700 for generating synthetic training data, in accordance with one or more embodiments of the disclosure. The example method 600 can be implemented, entirely or in part, by a computing device having one or more processors, one or more memory devices, and/or other types of computing resources. In some embodiments, the computing system can be embodied in or can include the machine condition monitoring system 200 or the AL-DAE system 120. The example method 700 can be implemented as a part of or in combination with the example method 600.

At block 710, the computing device can select an element from a training dataset. As mentioned, the training dataset can correspond to normal sensor output data from d sensors, where d is a natural number greater than unity. Accordingly, the training dataset can include multiple d-dimensional vectors, each having d components that correspond to respective sensors. Therefore, the element that is selected has multiple components corresponding to respective sensors.

At block 720, the computing device can determine a binary parameter using a first probability distribution. The binary parameter corresponds to a component of the multiple components and is indicative of an anomaly condition of a first sensor of the respective sensors. As mentioned, the anomaly condition can reveal absence of an anomaly (normal condition) or presence of an anomaly (fault condition). In one example, the first sensor can correspond to a sensor i of the d sensors and the anomaly condition can be labeled as zᵢ, which represents the binary parameter. As such, zᵢ can have one of two values: zᵢ=1 corresponding, for example, to a fault condition of the sensor i; or zᵢ=0 corresponding, for example, to a normal condition of the sensor i.

At block 730, the computing device can determine a synthetic value using a second probability distribution based at least on the binary parameter. The synthetic value corresponds to the component and is indicative of synthetic output for the sensor that corresponds to the binary value determined at block 620.

At block 740, the computing device can determine if the component is the d-th component in the element. In other words, the computing device can determine if a last component of a synthetic sample has been generated. A negative determination causes the flow of the example method 600 to be directed to block 620, for generation of an additional component of the synthetic sample. In the alternative, an affirmative determination can cause the example method 600 to end.

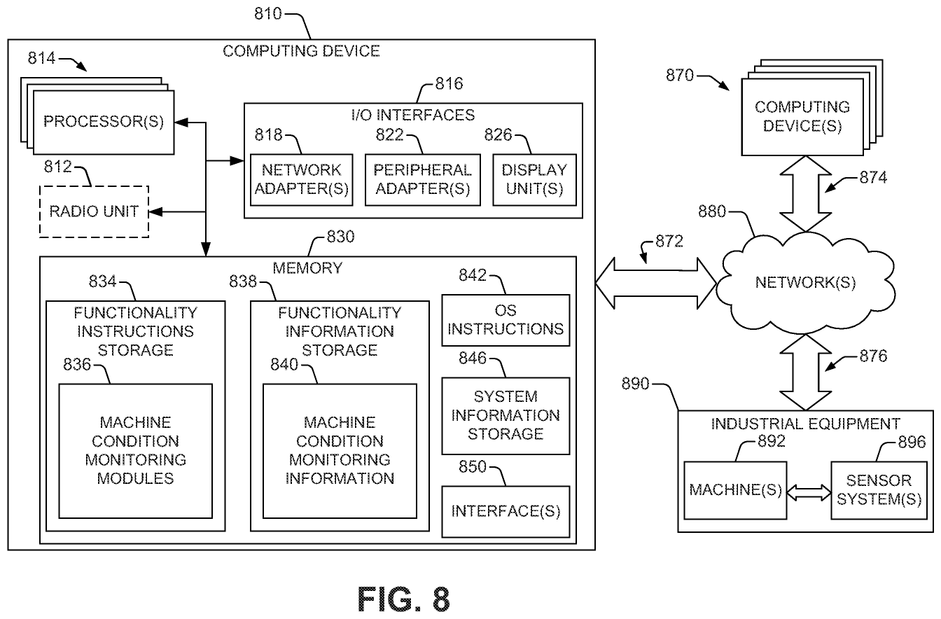

FIG. 8 presents an example of an operational environment in which functionality associated with machine condition monitoring can be implemented in accordance with one or more embodiments of the disclosure. The exemplified operational environment 800 is merely illustrative and is not intended to suggest or otherwise convey any limitation as to the scope of use or functionality of the operational environment's architecture. In addition, the exemplified operational environment 800 depicted in FIG. 8 should not be interpreted as having any dependency or requirement relating to any one or combination of modules or other types of components illustrated in other example operational environments of this disclosure.

The example operational environment 800 or portions thereof can embody or can constitute other ones of the various operational environments and systems described hereinbefore. As such, the computing device 810, individually or combination with at least one of the computing device(s) 870), can embody or can constitute the AL-DAE 120 or the machine condition monitoring system 200 described herein.

In one example, the computing device 810 can be embodied in a portable personal computer or a handheld computing device, such as a mobile tablet computer or the like. In another example, the computing device 810 can be embodied in a wearable computing device. The computing device 810 also can embody or can constitute other types of mobile computing devices.

The computational environment 800 represents an example implementation of the various aspects or elements of the disclosure in which the processing or execution of operations described in connection with machine condition monitoring in accordance with aspects disclosed herein can be performed in response to execution of one or more software components at the computing device 810. Such one or more software components render the computing device 810 (or any other computing device that contains the software component(s) a particular machine for machine condition monitoring in accordance with aspects described herein, among other functional purposes.

A software component can be embodied in or can include one or more computer-accessible instructions (e.g., computer-readable and/or computer-executable instructions). In some embodiments, as mentioned, at least a portion of the computer-accessible instructions can be executed to perform in at least a part of one or more of the example methods (e.g., method 600 and method 700) and/or other techniques described herein.

For instance, to embody one such method, at least the portion of the computer-accessible instructions can be retained in a computer-readable storage non-transitory medium and executed by one or more processors (e.g., at least one of processor(s) 814). The one or more computer-accessible instructions that embody or otherwise constitute a software component can be assembled into one or more program modules, for example. Such program module(s) can be compiled, linked, and/or executed (by one or more of the processor(s) 814) at the computing device 810 or other computing devices.

Further, such program module(s) can include computer code, routines, programs, objects, components, information structures (e.g., data structures and/or metadata structures), etc., that can perform particular tasks (e.g., one or more operations) in response to execution by one or more processors. At least one of such processor(s) can be integrated into the computing device 810. For instance, the one or more processor that can execute the program module(s) can be embodied in or can include a non-empty subset the processor(s) 814. In addition, at least another one of the processor(s) can be functionally coupled to the computing device 810.

The various example embodiments of the disclosure can be operational with numerous other general purpose or special purpose computing system environments or configurations. Examples of well-known computing systems, environments, and/or configurations that can be suitable for implementation of various aspects or elements of the disclosure in connection with machine condition monitoring in accordance with aspects of this disclosure can include personal computers; server computers; laptop devices; handheld computing devices, such as mobile tablets or e-readers; wearable computing devices; and multiprocessor systems. Additional examples can include, programmable consumer electronics, network personal computers (PCs), minicomputers, mainframe computers, blade computers, programmable logic controllers, distributed computing environments that comprise any of the above systems or devices, and the like.

As is illustrated in FIG. 8, the computing device 810 includes one or more processors 814, one or more input/output (I/O) interfaces 816; one or more memory devices 830 (collectively referred to as memory 830); and a bus architecture 832 (also termed bus 832). The bus architecture 732 functionally couples various functional elements of the computing device 810. The bus 832 can include at least one of a system bus, a memory bus, an address bus, or a message bus, and can permit or otherwise facilitate the exchange of information (data, metadata, and/or signaling) between the processor(s) 714, the I/O interface(s) 716, and/or the memory 730, or respective functional elements therein. In some scenarios, the bus 732 in conjunction with one or more internal programming interfaces 850 (collectively referred to as interface(s) 850) can permit or otherwise facilitate such exchange of information. In scenarios in which the processor(s) 714 include multiple processors, the computing device 810 can utilize parallel computing.

In some embodiments, the computing device 810 can include, optionally, a radio unit 812. The radio unit 812 can include one or more antennas and a communication processing unit that can permit wireless communication between the computing device 810 and another device, such as one of the computing device(s) 870 or a sensor device of the sensor system(s) 896.

The I/O interface(s) 816 can permit or otherwise facilitate communication of information between the computing device 810 and an external device, such as another computing device (e.g., a network element or an end-user device) or a sensor device. Such communication can include direct communication or indirect communication, such as the exchange of information between the computing device 810 and the external device via a network or elements thereof. In some embodiments, as is illustrated in FIG. 8, the I/O interface(s) 816 can include one or more of network adapter(s) 818, peripheral adapter(s) 822, and display unit(s) 826. Such adapter(s) can permit or otherwise facilitate connectivity between the external device and one or more of the processor(s) 814 or the memory 830. For example, the peripheral adapter(s) 822 can include a group of ports, which can include at least one of parallel ports, serial ports, Ethernet ports, V.35 ports, or X.21 ports. In certain embodiments, the parallel ports can comprise General Purpose Interface Bus (GPIB), IEEE-1284, while the serial ports can include Recommended Standard (RS)-232, V.11, Universal Serial Bus (USB), FireWire or IEEE-1394.

At least one of the network adapter(s) 818 can functionally couple the computing device 810 to one or more computing devices 870 via one or more communication links (wireless, wireline, or a combination thereof) and one or more networks 880 that, individually or in combination, can permit or otherwise facilitate the exchange of information (data, metadata, and/or signaling) between the computing device 810 and the one or more computing devices 870. Such network coupling provided at least in part by the at least one of the network adapter(s) 718 can be implemented in a wired environment, a wireless environment, or both. The network(s) 880 can include several types of network elements, including base stations; router devices; switch devices; server devices; aggregator devices; bus architectures; a combination of the foregoing; or the like. The network elements can be assembled to form a local area network (LAN) a metropolitan area network (MAN), a wide area network (WAN), and/or other networks (wireless or wired) having different footprints.

Information that is communicated by at least one of the network adapter(s) 818 can result from the implementation of one or more operations of a method (or technique) in accordance with aspects of this disclosure. Such output can be any form of visual representation, including textual, graphical, animation, audio, haptic, and the like. In some scenarios, each one of the computing device(s) 870 can have substantially the same architecture as the computing device 810. In addition or in the alternative, the display unit(s) 826 can include functional elements (e.g., lights, such as light-emitting diodes; a display, such as a liquid crystal display (LCD), a plasma monitor, a light-emitting diode (LED) monitor, or an electrochromic monitor; combinations thereof; or the like) that can permit or otherwise facilitate control of the operation of the computing device 810, or can permit conveying or revealing the operational conditions of the computing device 810.

In one aspect, the bus architecture 832 represents one or more of several possible types of bus structures, including a memory bus or a memory controller, a peripheral bus, an accelerated graphics port, and a processor or local bus using any of a variety of bus architectures. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and the like.

The bus architecture 832, and all other bus architectures described herein can be implemented over a wired or wireless network connection and each of the subsystems, including the processor(s) 814, the memory 830 and memory elements therein, and the I/O interface(s) 816 can be contained within one or more remote computing devices 870 at physically separate locations, connected through buses of this form, in effect implementing a filly distributed system.

In some embodiments, such a distributed system can implement the functionality described herein in a client-host or client-server configuration in which the machine condition monitoring modules 836 or the machine condition monitoring information 840, or both, can be distributed between the computing device 810 and at least one of the computing device(s) 870, and the computing device 810 and at least one of the computing device(s) 870 can execute such modules and/or leverage such information.

The computing device 810 can include a variety of computer-readable media. Computer-readable media can be any available media (transitory and non-transitory) that can be accessed by the computing device 810. In one aspect, computer-readable media can include computer non-transitory storage media (or computer-readable non-transitory storage media) and communications media. Example computer-readable non-transitory storage media can include, for example, both volatile media and non-volatile media, and removable and/or non-removable media. In one aspect, the memory 830 can include computer-readable media in the form of volatile memory, such as random access memory (RAM), and/or non-volatile memory, such as read-only memory (ROM).

As is illustrated in FIG. 8, the memory 830 can include functionality instructions storage 834 and functionality information storage 838. The functionality instructions storage 834 can include computer-accessible instructions that, in response to execution (by at least one of the processor(s) 814, for example), can implement one or more of the machine condition monitoring functionalities of the disclosure. The computer-accessible instructions can embody or can comprise one or more software components illustrated as call response control component(s) 836.

In one scenario, execution of at least one component of the call response control component(s) 836 can implement one or more of the methods disclosed herein, such as the example methods 600 and 700. For instance, such execution can cause a processor (e.g., one of the processor(s) 814) that executes the at least one component to carry out a disclosed example method or another technique of this disclosure.

It is noted that, in one aspect, a processor of the processor(s) 814 that executes at least one of the machine condition monitoring modules 836 can retrieve information from or retain information in one or more memory elements 840 in the functionality information storage 838 in order to operate in accordance with the functionality programmed or otherwise configured by the machine condition monitoring modules 836. The one or more memory elements 840 can be generically referred to as machine condition monitoring information 840. Such information can include at least one of code instructions, information structures, or the like. For instance, at least a portion of such information structures can be indicative or otherwise representative of model parameters {Ω}; normal sensor output data 256, synthetic output data 258; binary data; a combination thereof; and the like, in accordance with aspects described herein.

In some embodiments, one or more of the machine condition monitoring modules 836 can embody or can constitute, for example, the synthetic data generator module 240, the module generator module 260, the data acquisition module 240, and/or the estimator module 280 in accordance with aspects of this disclosure.

At least one of the one or more interfaces 850 (e.g., application programming interface(s)) can permit or otherwise facilitate communication of information between two or more modules within the functionality instructions storage 834. The information that is communicated by the at least one interface can result from implementation of one or more operations in a method of the disclosure. In some embodiments, one or more of the functionality instructions storage 834 and the functionality information storage 838 can be embodied in or can comprise removable/non-removable, and/or volatile/non-volatile computer storage media.

At least a portion of at least one of the machine condition monitoring modules 836 or the machine condition monitoring information 840 can program or otherwise configure one or more of the processors 814 to operate at least in accordance with the machine condition monitoring functionality disclosed herein. One or more of the processor(s) 814 can execute at least one of the machine condition monitoring modules 836 and leverage at least a portion of the information in the functionality information storage 838 in order to provide management of calls from unknown callers in accordance with one or more aspects described herein.

It is noted that, in some embodiments, the functionality instructions storage 834 can embody or can comprise a computer-readable non-transitory storage medium having computer-accessible instructions that. in response to execution, cause at least one processor (e.g., one or more of the processor(s) 814) to perform a group of operations comprising the operations or blocks described in connection with the example methods 600 and 700 and other techniques disclosed herein.

The memory 830 also can include computer-accessible instructions and information (e.g., data, metadata, and/or programming code instructions) that permit or otherwise facilitate the operation and/or administration (e.g., upgrades, software installation, any other configuration, or the like) of the computing device 810. Accordingly, as is illustrated, the memory 830 includes a memory element 842 (labeled operating system (OS) instructions 842) that contains one or more program modules that embody or include one or more operating systems, such as Windows operating system, Unix, Linux, Symbian, Android, Chromium, and substantially any OS suitable for mobile computing devices or tethered computing devices. in one aspect, the operational and/or architectural complexity of the computing device 810 can dictate a suitable OS.

The memory 830 further includes a system information storage 846 having data, metadata, and/or programming code (e.g., firmware) that can permit or otherwise can facilitate the operation and/or administration of the computing device 810. Elements of the OS instructions 842 and the system information storage 846 can be accessible or can be operated on by at least one of the processor(s) 814.

While the functionality instructions storage 834 and other executable program components (such as the OS instructions 842) are illustrated herein as discrete blocks, such software components can reside at various times in different memory components of the computing device 810 and can be executed by at least one of the processor(s) 814. In certain scenarios, an implementation of the machine condition monitoring 836 can be retained on or transmitted across some form of computer-readable media.

The computing device 810 and/or one of the computing device(s) 870 can include a power supply (not shown in FIG. 8), which can power up components or functional elements within such devices. The power supply can be a rechargeable power supply, e.g., a rechargeable battery, and it can include one or more transformers to achieve a power level suitable for the operation of the computing device 810 and/or one of the computing device(s) 870, and components, functional elements, and related circuitry therein. In certain scenarios, the power supply can be attached to a conventional power grid to recharge and ensure that such devices can be operational. In one aspect, the power supply can include an I/O interface one of the network adapter(s) 818) to connect operationally to the conventional power grid. In another aspect, the power supply can include an energy conversion component, such as a solar panel, to provide additional or alternative power resources or autonomy for the computing device 810 and/or one of the computing device(s) 870.

As is illustrated in FIG. 8, in some instances, the computing device 810 can operate in a networked environment by utilizing connections to one or more remote computing devices 870. As an illustration, a remote computing device can be a personal computer, a portable computer, a server, a router, a network computer, a peer device or other common network node, and so on. As described herein, connections (physical and/or logical) between the computing device 810 and a computing device of the one or more remote computing devices 870 can be made via one or more networks 880, and various communication links (wireless or wireline). The network(s) 880 can include several types of network elements, including base stations; router devices; switch devices; server devices; aggregator devices; bus architectures; a combination of the foregoing; or the like. The network elements can be assembled to form a local area network (LAN), a metropolitan area network (MAN), a wide area network (WAN), and/or other networks (wireless or wired) having different footprints.

In addition, as is illustrated the communication links can be assembled in a first group of communication links 874 and a second group of communication links 872. Each one of the communication links in both groups can include one of an upstream link (or uplink (UL)) or a downstream link (or downlink (DL)). Each one of the UL and the DL can be embodied in or can include wireless links (e.g., deep-space wireless links and/or terrestrial wireless links), wireline links optic-fiber lines, coaxial cables, and/or twisted-pair lines), or a combination thereof.

The first group of communication links 874 and the second group of communication links 872 can permit or otherwise facilitate the exchange of information (e.g., data, metadata, and/or signaling) between at least one of the computing device(s) 870 and the computing device 810. To that end, one or more links of the first group of communication links 874, one or more links of the second group of communication links 874, and at least one of the network(s) 880 can form in a communication pathway between the communication device 810 and at least one of the computing device(s) 870.

In one or more embodiments, one or more of the disclosed methods can be practiced in distributed computing environments, such as grid-based environments, where tasks can be performed by remote processing devices (computing device(s) 870) that are functionally coupled (e.g., communicatively linked or otherwise coupled) through at least one of network(s) 810. In a distributed computing environment, in one aspect, one or more software components (such as program modules) can be located within both a local computing device (e.g., computing device 810) and at least one remote computing device.

In some embodiments, as is illustrated in FIG. 8, the operational environment 800 can include industrial equipment 890, such as a gas turbine. The industrial equipment 890 includes one or more machines 892 and one or more sensor systems 896 that can probe the machine. In one aspect, the machine(s) 892 can be embodied in or can include the industrial machine 110. In addition, at least one of the sensor system(s) 896 can be embodied in or can include sensor devices 118₁-118_{D}. The computing device 810 and at least one of the computing device(s) 870, individually or in combination, can monitor a condition of the industrial equipment 890 in accordance with aspects of this disclosure. To that end, in some aspects, multiple sensor devices of the sensory system(s) 896 can be functionally coupled (e.g., communicatively coupled, electrically coupled, and/or electromechanically coupled) to the computing device 810 and/or at least one of the computing device(s) 870. Specifically, one or more of the sensor devices can communicate with the computing device 810 via a communication pathway formed by communication links 876, at least one of network(s) 880, and communication links 872. Similarly, the sensor device(s) can communicate with at least one of the computing devices 870 via another communication pathway formed by the communication links 876, at least one of the network(s) 880, and the communication links 874.

Communication links 876 and communication links 872 can permit or otherwise facilitate the exchange of information (e.g., data, metadata, and/or signaling) between the sensor devices of the sensor system(s) 896 and the computing device. Similarly, communication links 876 and communication links 874 can permit or otherwise facilitate the exchange of information (e.g., data, metadata, and/or signaling) between the sensor devices of the sensor system(s) 896 and one or more of the computing device(s) 870. Communication links 876 includes, for example, an upstream link (or uplink (UL)) and a downstream link (or downlink (DL)). Each one of the UL and the DL can be embodied in or can include wireless links (e.g., deep-space wireless links and/or terrestrial wireless links), wireline links (e.g., optic-fiber lines, coaxial cables, and/or twisted-pair lines), or a combination thereof.

Various embodiments of the disclosure may take the form of an entirely or partially hardware embodiment, an entirely or partially software embodiment, or a combination of software and hardware (e.g., a firmware embodiment). Further, as described herein, various embodiments of the disclosure (e.g., systems and methods) may take the form of a computer program product including a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can be embodied in or can include ROM; RAM; magnetic disk storage media; optical storage media; flash memory, etc.

At least some of the embodiments of the operational environments and techniques are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or technique put firth herein be construed as requiring that its acts or steps be performed in a specific order. Accordingly, where a process or a method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of embodiments described in the specification or annexed drawings, or the like.

As used in this application, the terms “environment,” “system,”“module,” “component,” “architecture,” “interface,” “unit,” and the like refer a computer-related entity or an entity related to an operational apparatus with one or more defined functionalities. The terms “environment,” “system,” “module,” “component,” “architecture,” “interface,” and “unit,” can be utilized interchangeably and can be generically referred to functional elements. Such entities may be either hardware, a. combination of hardware and software, software, or software in execution. As an example, a module can be embodied in a process miming on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

As is utilized in this disclosure, the term “processor” can refer to any type of processing circuitry or device. A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory.

Additionally, or as another example, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed or otherwise configured (e.g., manufactured) to perform the functions described herein.

In some embodiments, processors can utilize nanoscale architectures. In order to optimize space usage or enhance the performance of systems, devices, or other electronic equipment in accordance with this disclosure. For instance, a processor can include molecular transistors and/or quantum-dot based transistors, switches, and gates.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Memory components or memory devices disclosed herein can be embodied in either volatile memory or non-volatile memory or can include both volatile and non-volatile memory. In addition, the memory components or memory devices can be removable or non-removable, and/or internal or external to a computing device or component. Examples of various types of non-transitory storage media can include hard-disc drives, zip drives. CD-ROMs, digital versatile disks (DVDs) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory devices or memories of the operational or computational environments described herein are intended to include one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The flowchart and block diagrams in the Figures illustrate the architecture, functionality, and operation of possible implementations of examples of systems, methods, and computer program products according to various embodiments of the present disclosure. In this regard, each block in the flowchart or block diagrams may represent a module, segment, or portion of instructions, which includes one or more machine- or computer-executable instructions for implementing the specified operations. It is noted that each block of the block diagrams and/or flowchart illustration, and combinations of blocks in the block diagrams and/or flowchart illustration, can be implemented by special purpose hardware-based systems that perform the specified functions or operations or carry out combinations of special purpose hardware and computer instructions.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable non-transitory storage medium within the respective computing/processing device.

What has been described herein in the present specification and annexed drawings includes examples of systems, devices, techniques, and computer program products for machine condition monitoring that permits determining state estimation and anomaly localization jointly, in a single operation. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A computer-implemented method, comprising:
receiving, by a computing system including at least one processor, a first dataset representative of normal output data from sensor devices coupled to an industrial machine;
generating, by the computing system, a binary dataset representative of anomaly states of the industrial machine;
generating, by the computing system, using at least the first dataset and the binary dataset, a second dataset representative of synthetic output data corresponding to the sensor devices;
determining, by the computing system, a model using at least the first dataset, the second dataset, and the binary dataset, the model estimates jointly an operational state of the industrial machine and anomaly localization within the industrial equipment.

2. The computer-implemented method of claim I, wherein the receiving comprises receiving multiple vectors corresponding to a defined mode of operation of the industrial machine, each one of the multiple vectors corresponding to a respective one of the sensor devices.

3. The computer-implemented method of claim 1, wherein the generating the binary dataset comprises generating respective binary values for the sensor devices according to a defined probability distribution, wherein each binary value of the binary values indicates one of presence of an anomaly at a respective sensor device of the sensor devices or a normal state of the respective sensor device.

4. The method of claim 3, wherein the generating the second dataset comprises generating a first datum according to a second defined probability distribution based at least on a datum of the first dataset and a binary value of the respective binary values.

5. The computer-implemented method of claim 1, wherein the determining comprises solving an optimization problem with respect to a defined objective function including a sum of log-likelihood elements based at least on the first dataset, the second dataset, and the binary dataset.

6. The computer-implemented method of claim 5, wherein the solving the optimization problem comprises determining a maximum of the sum of log-likelihood elements by performing an estimation-maximization process.

7. The computer-implemented method of claim 1, further comprising:
receiving, by the computing system, data indicative of observed output from the sensor devices; and
determining jointly, by the computing system, an estimate of the operational state and an estimate of the anomaly localization by applying the model to the data.

8. The computer-implemented method of claim 7, further comprising providing the estimate of the operational state and the estimate of the anomaly localization.

9. A system, comprising:
at least one memory device having stored therein computer-executable instructions; and
at least one processor configured to access the at least one memory device and execute the computer-executable instructions to:
receive a first dataset representative of normal output data from sensor devices coupled to an industrial machine;
generate a binary dataset representative of anomaly states of the industrial machine;
generate, using at least the first dataset and the binary dataset, a second dataset representative of synthetic output data corresponding to the sensor devices;
determine a model using at least the first dataset, the second dataset, and the binary dataset, the model estimates jointly an operational state of the industrial machine and anomaly localization within the industrial equipment.

10. The system of claim 9, wherein to receive the first dataset, the at least one processor executes the computer-executable instructions to receive multiple vectors corresponding to a defined mode of operation of the industrial machine, each one of the multiple vectors corresponding to a respective one of the sensor devices.

11. The system of claim 9, wherein to generate the binary dataset, the at least one processor executes the computer-executable instructions to generate respective binary values for the sensor devices according to a defined probability distribution, wherein each binary value of the binary values indicates one of presence of an anomaly at a respective sensor device of the sensor devices or a normal state of the respective sensor device.

12. The system of claim 11, wherein to generate the second dataset, the at least one processor executes the computer-executable instructions to generate a first datum according to a second defined probability distribution based at least on a datum of the first dataset and a binary value of the respective binary values.

13. The system of claim 9, wherein to determine the model, the at least one processor executes the computer-executable instructions to solve an optimization problem with respect to a defined objective function including a sum of log-likelihood elements based at least on the first dataset, the second dataset, and the binary dataset.

14. The system of claim 13, wherein solve the optimization problem, the at least one processor executes the computer-executable instructions to determine a maximum of the sum of log-likelihood elements by performing an estimation-maximization process.

15. The system of claim 9, wherein the at least one processor is further configured to execute the computer-executable instructions to:
receive data indicative of observed of om the sensor devices; and
determine jointly an estimate of the operational state and an estimate of the anomaly localization by applying the model to the data.

16. A computer program product comprising at least one non-transitory storage medium readable by at least one processing circuit, the non-transitory storage medium having encoded thereon instructions executable by the at least one processing circuit to perform or facilitate operations comprising:
receiving a first dataset representative of normal output data from sensor devices coupled to an industrial machine;
generating a binary dataset representative of anomaly states of the industrial machine;
generating, using at least the first dataset and the binary dataset, a second dataset representative of synthetic output data corresponding to the sensor devices;
determining a model using at least the first dataset, the second dataset, and the binary dataset, the model estimates jointly an operational state of the industrial machine and anomaly localization within the industrial equipment.

17. The computer program product of claim 16, wherein the generating the binary dataset comprises generating respective binary values for the sensor devices according to a defined probability distribution, wherein a first binary value of the binary values indicates one of presence of an anomaly at a first sensor device of the sensor devices or a normal state of the first sensor device.

18. The computer program product of claim 17, wherein the generating the second dataset comprises generating a first datum according to a second defined probability distribution based at least on a datum of the first dataset and the first binary value.

19. The computer program product of claim 16, wherein the determining comprises solving an optimization problem with respect to a defined objective function including a sum of log-likelihood elements based at least on the first dataset, the second dataset, and the binary dataset.

20. The computer program product of claim 16, wherein the operation further comprise:
receiving data indicative of observed output from the sensor devices; and
determining jointly an estimate of the operational state and an estimate of the anomaly localization by applying the model to the data.
